(19) United States
(12) Patent Application Publication
(10) Pub. No.: US 2015/0070499 A1
(43) Pub. Date: Mar. 12, 2015

(54) CAMERA SYSTEM, IN PARTICULAR FOR A VEHICLE

(71) Applicants: Volker Roelke, Leonberg (DE); Tobias Strauss, Karlsruhe (DE); Axel Schwarz, Baden-Baden (DE); Stephan Simon, Sibbesse (DE)

(72) Inventors: Volker Roelke, Leonberg (DE); Tobias Strauss, Karlsruhe (DE); Axel Schwarz, Baden-Baden (DE); Stephan Simon, Sibbesse (DE)

(21) Appl. No.: 14/370,950

(22) PCT Filed: Dec. 10, 2012
(86) PCT No.: PCT/EP2012/074914

§ 371 Date: Jul. 7, 2014

(30) Foreign Application Priority Data
Jan. 9, 2012 (DE) 10 2012 200 200.6

(51) Int. Cl. B60R 1/10

(52) U.S. Cl. CPC B60R 1/10; B60R 2300/106; B60R 2300/108; B60R 2300/8053
USPC 348/148

(57) ABSTRACT

A camera system, e.g., for a vehicle, includes: at least one objective for detecting a detection region, one image sensor for outputting image signals, and one auxiliary optics situated in the detection region, the auxiliary optics together with the objective forming an optical imaging system for imaging a two-dimensional detection region on the image sensor. The auxiliary optics is formed by one auxiliary lens having an entrance surface and an exit surface, and the two-dimensional detection region does not extend vertically with respect to the optical axis of the auxiliary lens and is imaged sharply on the image sensor by the optical imaging system. The entrance and exit surfaces do not have a spherical curvature.

### BACKGROUND OF THE INVENTION

1. Field of the Invention

The present invention relates to a camera system for a motor vehicle.

2. Description of the Related Art

Camera systems for detecting vehicle surroundings through a windshield of a vehicle, in particular a front windshield, are used in driver assistance systems in particular, for example, as part of a night vision system, as a warning system and/or as a stereo camera system for determining distances. The camera systems are situated in such a way that they detect the vehicle surroundings ahead of the vehicle in particular. The camera systems are therefore secured by camera mounts on the inside of the front windshield, for example, or on the roof of the vehicle or on a roof strut of the vehicle, where they detect the outside space ahead of the vehicle, in particular also the vehicle's own lane.

It is also known that camera systems may be used for secondary functions, for example, for ascertaining a film on the windshield, in particular as a rain detector.

Published international patent application document WO 2010/76065 A1 describes a camera system which images vehicle surroundings as a primary image and detects a region of an exterior surface of the windshield as a secondary image. To detect the secondary image, one mirror is provided in a lower part of the detection range and another mirror is provided above the objective. A film adhering to the outside of the windshield essentially above the objective is thus detected by the objective by deflection with the aid of two mirrors. In such a system, a sufficient installation space or room is necessary for arranging the deflection mirrors accordingly.

Published German patent application document DE 10 2004 015 040 A1 describes night vision support, lane departure warning or traffic sign recognition as the primary function and describes a rain sensor system for detecting droplets of water on the outside of the windshield as a secondary function. For this purpose, the camera system has a radiation source, from which optical radiation may first be coupled into the windshield and then coupled out again, the part that has been coupled out again being in turn detected by an image sensor. Water droplets adhering to the outside of the windshield affect the total reflection of light coupled into the windshield, so that the image sensor ascertains changes in the light signal.

Published German patent application document DE 102 01 522 A1 describes a camera system having a primary function such as, for example, the detection of objects, and as the secondary function, the detection of an obstructed view due to raindrops on the windshield. The image recorded is evaluated by an evaluation unit in order to be able to infer the existence of a film from the blur distribution.

Published German patent application document DE 103 23 560 A1 describes a camera in which a mirror is provided in the lower part of a detection region of the objective. The mirror detects a region of the vehicle's surroundings above the vehicle and deflects it to the objective, thereby making it possible for an ambient brightness to be ascertained.

Steffen Görmer et al., “Vision-based Rain Sensing with an In-Vehicle Camera,” 2009, IEEE; 978-1-4244-3503-6, describe a camera system which creates an optical image of a detection region as a secondary image on an image sensor. In addition to the objective, a lens and a mirror are provided for this purpose, so that an imaging system for a detection region on the vehicle window is made up of the objective, the lens and the mirror.

However, the equipment complexity of such imaging systems and their optical adjustment is not insignificant. The detection region is detected by a mirror situated beneath the detection region, so that the line of sight runs to the sky. With such a background, however, there is usually a lack of contrast in the image to make the structures of the droplets discernible in the images.

Detection of the transparent water drops is further impeded by the fact that the detectable structures, for example, the edges of the drops, are sometimes not very distinct and may recede in comparison with the structures of the image background, making them difficult to discern.

### BRIEF SUMMARY OF THE INVENTION

According to the present invention, a single auxiliary lens is positioned as the auxiliary optics in the detection region of the objective of the camera system. The objective of the camera, which generally has one or more lenses, and the auxiliary lens thus form the optical imaging system for imaging the detection region.

The detection region here is not vertically on the auxiliary lens axis and is imaged sharply on the image sensor by the optical imaging system made up of the objective and the auxiliary lens.

The auxiliary lens axis is understood here to refer to the straight line intersecting the entrance surface and the exit surface centrally. This auxiliary lens axis does not generally form an axis of symmetry because of the asymmetrical design, with unequal and nonparallel entrance and exit surfaces in the present case.

The detection region preferably has a smaller object distance in comparison with a portion of the detection region, which is detected as a primary image and preferably represents a region of the outside of the windshield or a film adhering to the outside of the windshield.

According to the present invention, there is no mirror provided to deflect the light emanating from the detection region to the auxiliary lens or to deflect this light between the auxiliary lens and the objective.

This yields the advantage that an optical alignment of different optical elements to one another is not necessary. It is preferably necessary only to position the auxiliary lens in relation to the objective and to position the entire camera system in the vehicle relative to the vehicle windshield, for example, with the aid of a camera mount on the inside of the windshield, on the roof or on a rearview mirror.

Another advantage according to the present invention is that the required installation space is small. Unlike optical systems having deflection mirrors, the detection region according to the present invention may be deflected to the objective or to the entrance pupil of the objective directly via the auxiliary lens. A detection region below the optical axis is preferably detected so that additional installation space above the camera is not necessary. The camera may thus also be mounted in an upper region of the front windshield, for example.

According to one specific embodiment, a normal of the detection region runs at an angle of at least 90° with respect to the optical axis of the auxiliary lens. A peripheral surface of the auxiliary lens formed between the entrance surface and the exit surface may run parallel to the inside of the windshield, entirely or in some regions.

If the camera is to be positioned close to the windshield in particular, this design may be advantageous, in order to obtain a long distance for the optical path.

This yields the advantage that at a given distance between the objective and the vehicle windshield, a sufficiently great distance may be formed between the objective and the detection region, so that the desired imaging properties such as tilting of the focus range into the detection region at an appropriate depth of field are achieved.

According to one preferred embodiment, the exit surface facing the rear, i.e., toward the objective, and the opposite entrance surface facing forward are not vertical to the optical axis of the auxiliary lens. In the case of a curved, nonplanar embodiment of the entrance or exit surface, this is understood to mean that tangential planes on the entrance and exit surfaces are not vertically on the optical axis of the auxiliary lens. The partial optical distances of the imaging system, which are connected to the entrance surface and the exit surface, are also not vertically on the entrance surface or the exit surface.

Therefore, refraction of light is in effect already on these optically active transition surfaces to achieve the desired optical properties using a single auxiliary lens.

The auxiliary lens is advantageously designed to be prismatic or wedge-shaped, i.e., its entrance surface and exit surface or the tangential planes on the entrance surface and exit surface are not parallel and are not of the same size. The auxiliary lens may therefore become wider away from the camera in particular.

Thus an optical imaging system is designed in which the detection region to be imaged is greatly inclined in relation to the optical axis of the auxiliary lens. However, it is recognized according to the present invention that such imaging is quite possible in the design of the entrance surface as a nonspherical surface in particular and permits good imaging properties. The exit surface of the auxiliary lens, i.e., the surface facing the objective, may be designed with a suitable curvature, in particular also an asymmetrical curvature with respect to the lens axis. It is preferably inclined with respect to the path of the optical axis between the entrance pupil of the objective and the auxiliary lens to permit refraction of light from an optical path essentially parallel to the windshield with a greater inclination toward the rear in relation to the objective. The optical path from the detection region advantageously runs initially through the windshield, from the windshield essentially to the rear to the entrance surface of the auxiliary lens, in which main beams of the light bundles emanating from points in the detection region run essentially parallel to the optical auxiliary axis until they are refracted out of the exit surface toward the rear.

According to one particularly preferred embodiment, a telecentric optical imaging system is formed on the object side. The imaging system made up of the objective and the auxiliary lens thus permits telecentric imaging on the object side, in which main beams of the light bundles run essentially in parallel toward the object side.

Such an embodiment in particular makes it possible for a background in the additional image to appear essentially uniform. The main beams of the light bundles running in parallel thus detect the same or essentially the same regions in the outside area of the vehicle since differences of a few millimeters or centimeters, for example, in the outside space are no longer relevant. Because of the essentially identical background, the film may be detected better as a structure in relation to the background than is the case with traditional systems, in which a region above the vehicle or next to the vehicle is detected as the secondary region, for example, because of light sources such as street lighting, houses, etc., and may also have definitely different intensities in detection of the sky in the vehicle surroundings.

An additional optical axis of the imaging system advantageously runs downward from the vehicle windshield for detecting a lower region of the vehicle surroundings, i.e., in particular a roadway, to form a uniform background. The background may thus detect in particular gray shades of the ground or a road surface. Due to this downward inclination of the additional axis, the influence of scattered light, for example, from street lights and other road users, may be minimized, so that the formation of a uniform background is improved.

A subsequent image recognition or classification of the detection region as a structure in relation to an essentially uniform background is thus made possible.

The camera system may thus be formed essentially by a camera having a camera housing, if necessary, an additional camera mount, for attaching it to the vehicle, and a one-piece auxiliary lens, which is attached to the camera housing, for example, or to the interconnect device of the camera or even to the camera mount. Unambiguous positioning and alignment are thus already made possible by fastening the auxiliary lens to the camera or the camera mount. The additional costs of the system according to the present invention are thus low and are determined essentially by the auxiliary lens, which may be manufactured in one piece from a transparent material, for example, by injection molding or casting.

The additional outside surface of the auxiliary lens, i.e., except the entrance surface and the exit surface, is preferably covered to prevent the admission of scattered light, for example, by being enameled or sprayed.

The auxiliary lens is preferably attached to an interconnect device and/or a camera housing of the camera system or a camera mount holding the camera system.

The entrance surface of the auxiliary lens may be calculated, for example, by finite element calculation.

Basically no supplementary light source is necessary for illumination of the detection region, but it may be provided for detection in the dark in particular.

The camera system according to the present invention is basically not limited to use in a vehicle. It may also be provided for imaging specific nonplanar detection regions, for example. Basically, even a complex detection region may be imaged in this way, for which the entrance surface and/or exit surface may be designed to be complex accordingly. Also possible here is/are an asymmetrical curvature and/or a curvature having inflection points, i.e., the curvature not only increases or decreases steadily in the lateral direction (away from the axis of the auxiliary lens, to the outside), but may also vary.

### BRIEF DESCRIPTION OF THE DRAWINGS

FIG. 1 shows a vehicle having a camera system according to one specific embodiment in a sectional view from the side.

FIG. 2 shows a schematic diagram of the optical path of the secondary image in FIG. 1.

FIG. 3 shows a schematic diagram of the image regions of the image sensor and of the optical path of the primary image.

### DETAILED DESCRIPTION OF THE INVENTION

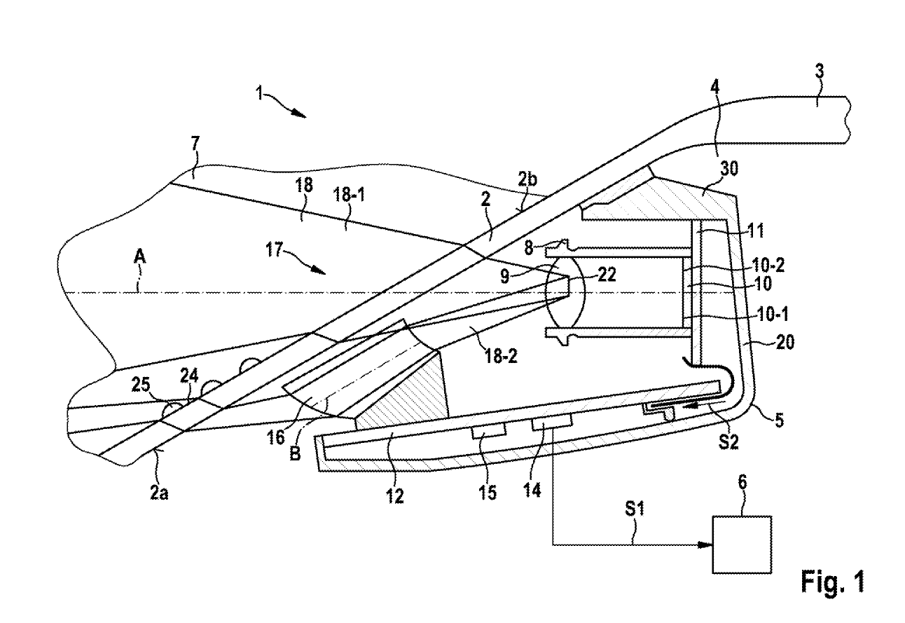

A windshield 2, a roof liner 3, a vehicle interior space 4 (passenger compartment) and a camera system 5 of a vehicle 1 are illustrated in FIG. 1. Camera system 5 is attached to inside 2a of windshield 2 and/or to roof liner 3 and outputs image signals S1 to an evaluation device 6, which may be outside of camera system 5 or may even be part of camera system 5 and is provided for various functions and functionalities, a main function optionally being detection and monitoring of vehicle surroundings (outside space) 7 outside of vehicle 1, in particular a roadway area ahead of vehicle 1, for display of vehicle surroundings 7 on a monitor in vehicle 1 and/or for a distance measurement as part of a stereo camera system and/or as a night vision system based on IR radiation, for example.

Camera system 5 has an objective 8 having one or more lenses 9 and an image sensor 10 (imager chip) which is mounted on a sensor carrier 11, and outputs imager signals S2 to an interconnect device 12 having components (circuit components) 14, 15, which in turn output image signals S1 to evaluation device 6. Evaluation device 6 may also be mounted on interconnect device 12 accordingly. Objective 8 defines a detection region 18 which extends forward from objective 8 in the direction of its optical axis A.

Camera system 5 additionally has an auxiliary lens 16, which forms auxiliary optics without any additional lenses or mirrors and, together with objective 8, forms an optical imaging system 17, which permits detection of a film 25 on outside 2b of windshield 2 as an additional function.

Detection range 18 includes in its upper part 18-1 part of vehicle surroundings 7 through windshield 2. Using its exterior part 18-2 (lower part in this specific embodiment) with respect to optical axis A, auxiliary lens 16 detects detection region 18. For example, auxiliary lens 16 is attached to interconnect device 12, a camera housing 20 of camera system 5 or also to a camera mount 30, for example, indicated in FIG. 1, which supports camera housing 20 and secures it on inside 2a of the windshield.

The optical properties of objective 8 are described below in particular with reference to its entrance pupil 22, which—in a known manner—represents a fictitious optical variable for the description of the optical behavior, optical axis A running through entrance pupil 22.

Imaging system 17 made up of auxiliary lens 16 and objective 8 images a detection region 24 on image sensor 10. Detection region 24 may be situated precisely on outside 2b of the windshield or situated slightly in front of outside 2b of the windshield in the direction of optical axis A (in the direction of travel). A film, for example, a water droplet 25 on outside 2b of the windshield, may be imaged on image sensor 10 in this way.

Auxiliary lens 16 has a rear exit surface 16a (in the direction of travel or with respect to optical axis A) and a front entrance surface 16b which thus represent the optically active surfaces, as well as a dark enameled peripheral surface 16c having a dark enameling, for example, which is irrelevant for the optical properties. Peripheral surface 16c may be essentially cylindrical, conical or even polygonal, for example.

Exit surface 16a and entrance surface 16b or the tangential planes of these surfaces are not parallel to one another. They preferably have an irregular curvature. On the whole, auxiliary lens 16 has a wedge-shaped and/or a prismatic design. Entrance surface 16b has a convex-concave curvature, for example. Entrance surface 16b has a nonspherical curvature. Its curvature facilitates accurate focusing on detection region 24 and advantageously has a more complex curvature. Exit surface 16a may also be formed with a more complex curvature accordingly. Basically, however, with a planar exit surface 16a, the optical properties may also be completely adjusted via entrance surface 16b.

The geometric shape of exit surface 16a and in particular of entrance surface 16b may also be ascertained by a finite element calculation.

Auxiliary lens 16 here may extend essentially parallel to front windshield 2, i.e., the portion of the line, close to inside 2a of front windshield 2, of peripheral surface 16c having longitudinal extent L shown in the figure runs entirely or essentially parallel to inside 2a of front windshield 2. An auxiliary lens axis B runs centrally, i.e., at the middle, through exit surface 16a and entrance surface.

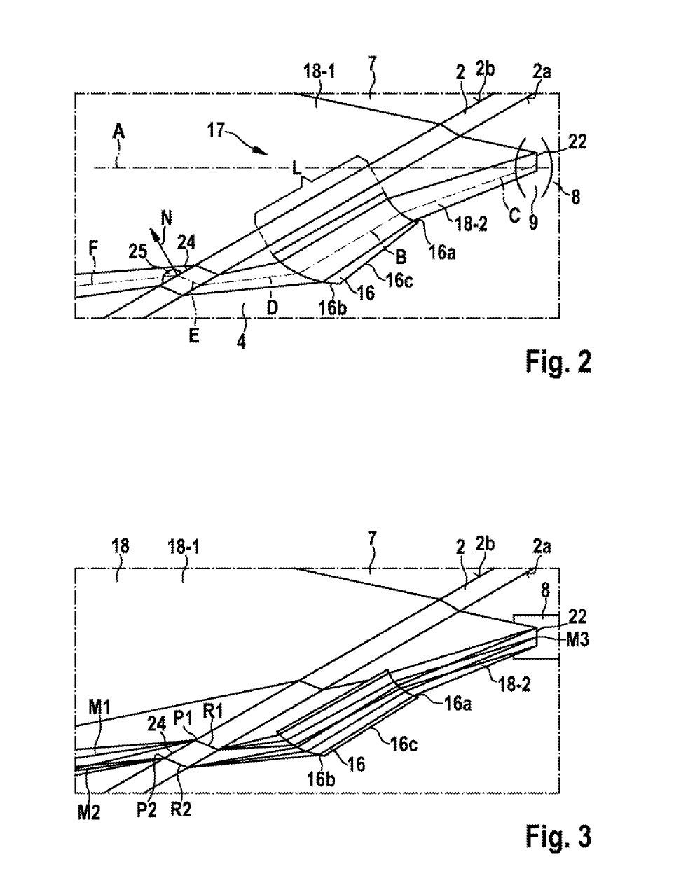

Detection region 24 does not extend vertically to auxiliary lens axis B but instead almost in parallel or at a very shallow angle. A normal N to detection region 24, as shown in FIG. 2, thus runs at an angle of approximately 90° to auxiliary lens axis B, for example, or even more than 90°. However, another angle may also be formed in other positions of the camera and in particular of the auxiliary lens.

Detection region 24 is imaged on image sensor 10 in a secondary image 10-2 together with primary image 10-1, which is detected in first part 18-1 of detection region 18. Images 10-1 and 10-2 are indicated in FIG. 1 and are shown here one above the other; they may also overlap.

The optical auxiliary axis of imaging system 17 initially runs forward and downward from entrance pupil 22 of objective 9 at a subsection C at an acute angle with respect to optical axis A, and reaches exit surface 16a not vertically; exit surface 16a runs at a shallower angle (closer to the horizontal) in comparison with subsection C. The optical path—as seen from entrance pupil 22, i.e., in the opposite direction in comparison with the optical path—is deflected downward here from subsection C. Auxiliary lens axis B runs downward at an angle to entrance surface 16b in comparison with subsection C. Entrance surface 16b is also not vertical with respect to auxiliary lens axis B, but instead runs at a shallower angle (closer to the horizontal plane), so that light or radiation again runs at a shallower angle in its passage through entrance surface 16b to the left (as seen in the direction opposite the actual propagation of light).

Next the optical auxiliary axis extends shallower again in a subsection D between auxiliary lens 16 and front windshield 2 or at a small angle with respect to optical axis A, and strikes inside 2a of the windshield at an acute angle, where the light is again refracted further upward into front windshield 2, which has a higher optical density. In front windshield 2, the light travels along subsection E, which is not parallel to normal N, to detection region 24 on or in front of outside 2b of the windshield. The optical auxiliary lens axis runs from outside 2b of the windshield to the left along subsection F, which is inclined downward with respect to a horizontal plane and preferably also with respect to the optical axis and thus detects a road surface.

Optical axis A may be parallel to the horizontal plane or may also be inclined slightly up or down. However, subsection F runs in the direction of travel or downward relative to the vehicle's surroundings (outside space) 7.

It is thus noteworthy in particular that with this optical equipment, detection region 24 is at a very large angle to (curved) entrance surface 16b. Detection region 24 is nevertheless imaged sharply on image sensor 10, which is achieved by the shape of entrance surface 16a and exit surface 16b.

The auxiliary lens is made in one piece of an optically transparent material having a higher optical density with respect to light such as mineral glass, for example, or a transparent plastic, e.g., acrylic glass. It may preferably be a pressed part or a cast part, which may thus be designed to be inexpensive. Basically, no reworking of exit surface 16a and entrance surface 16b is necessary. Peripheral surface 16c (side surface) is advantageously darkened by enameling or some other coating or by injection molding using plastic material to prevent scattered light.

It is basically also possible for auxiliary lens 16 to be positioned above optical axis A or at the side of it. For reasons of positioning the installation of the lens in vehicle 1, however, the specific embodiment shown here is advantageous since the auxiliary optics does not interfere with the image detection in relevant part 18-1 of detection region 18 with the road scene ahead of the vehicle and with traffic signs, traffic lights, etc., situated above it, for example, but instead only a lower region, for example, leading up to the hood of vehicle 1. The road surface, i.e., the road, is advantageously fully visible in the primary region up to the visible edge, which is determined by the hood, i.e., the secondary function does not interfere with the primary function.

In addition, because of the declining slope of front windshield 2, the optical path between detection region 24 and entrance pupil 22 is much larger than it would be if the lens were positioned above optical axis A, where entrance pupil 22 is already close to front windshield 2 and thus only a shallow depth of field is possible due to the small optical path available to image the film formed on outside 2b of the windshield and also to minimize optical defects and aberrations. With the design shown in FIG. 1, for example, the optical path between detection region 24 and entrance pupil 22 may be on the order of magnitude of the dimensioning of camera system 5.

In FIG. 3, beam bundles are shown to illustrate the optical path of the secondary image. The optical path here is shown from an upper point P1 of detection region 24 and a lower point P2 of detection region 24 (object points, detection points) up to entrance pupil 22. The further optical path from entrance pupil 22 to image sensor 10 is not shown further here accordingly. Beam bundles R1 and R2 emanating from two points P1, P2 thus each detect entire entrance pupil 22. Beam bundles R1 and R2 are defined by their main beams M1 and M2. Main beams M1 and M2 reach a midpoint M3 of entrance pupil 22 accordingly. The two outer beams of beam bundles R1, R2 are guided to the outer points of entrance pupil 22 accordingly. With the further optical path from entrance pupil 22 to image sensor 10, beam bundles R1, R2 merge again subsequently, and each is imaged in one pixel for upper point P1 and in one additional pixel for lower point P2.

In this representation, it is found that main beams M1, M2 run essentially in parallel to auxiliary lens 16 on the object side, i.e., from entrance surface 16b to front windshield 2 and from there further into the vehicle surroundings (outside space) 7. Objective 8 and auxiliary lens 16 thus form a telecentric imaging system 17 on the object side. Beam bundles R1 and R2 thus detect essentially the same region, for example, a region of the road ahead of vehicle 1 in vehicle surroundings 7. The offset of main beams M1 and M2 is insignificant here and is in the range of mm or cm, for example. Defocusing increases at a distance from front windshield 2, i.e., toward the left in the figures. Due to the marked defocusing at distances in the meter range, beam bundles R1 and R2 detect essentially averaged gray values without a structure. Due to the telecentric arrangement, these gray values and averaged values are also essentially the same since essentially the same regions are detected.

Structures in detection region 24, for example, due to a film 25 such as water droplets, may thus be imaged against a uniform background without structures. This permits image recognition of film 25, e.g., through edge detection.

Due to the wedge-shaped or prismatic design of the auxiliary lens, a wavelength-dispersive refraction of light may occur. Monochromatic light or light limited to a narrow wavelength range (for example, by using a filter layer on image sensor 10 or as part of image sensor 10) is therefore preferably used at least for the secondary image. The wavelength may be in the visible range or in the IR range. When used as a night vision system, image sensor 10 is designed completely in the IR range, for example.

In addition, the wavelength-dispersive refraction of light may also be utilized with the aid of a color sensor, for example, a color filter mask having a Bayer pattern in front of the pixels by recording and evaluating in multiple color channels, for example, and then subsequently processing the results of the measurements at various wavelengths with one another.

In addition, a light source may be provided for illumination of detection region 24, in particular in darkness. Such a light source is usually designed as a triggered LED, which outputs radiation through the front windshield to detection region 24 from the inside of the vehicle.

Evaluation device 6 may trigger a display device in the vehicle on the basis of this additional function, for example, and/or may optionally also initiate a windshield wiper function directly and/or may control time intervals of the windshield function.

1-16. (canceled)

17. A camera system for a motor vehicle, comprising:
an objective for detecting a detection region;
an image sensor for outputting image signals;
an auxiliary optics situated in the detection region, wherein the auxiliary optics and the objective together form an optical imaging system for imaging a two-dimensional detection area on the image sensor, and wherein the auxiliary optics is made up of precisely one auxiliary lens having an entrance surface and an exit surface, and the two-dimensional detection area does not extend vertically in relation to the optical axis of the auxiliary lens and is imaged sharply on the image sensor by the optical imaging system.

18. The camera system as recited in claim 17, wherein the detection region includes a first portion for detecting the surroundings of the vehicle through a windshield of the vehicle and a second portion adjacent to the first portion for detection by the auxiliary lens of the optical imaging system, and wherein the optical imaging system is configured to image one of the outside of the windshield of the vehicle or a film on the outside of the windshield of the vehicle through the windshield.

19. The camera system as recited in claim 18, wherein at least one of the exit surface of the auxiliary lens facing the objective and the entrance surface of the auxiliary lens opposite the exit surface is not vertically on the optical axis of the auxiliary lens.

20. The camera system as recited in claim 18, wherein at least one of the entrance surface and the exit surface of the auxiliary lens does not have a spherical curvature.

21. The camera system as recited in claim 18, wherein tangential surfaces of the entrance surface and tangential surfaces of the exit surface are not parallel to one another.

22. The camera system as recited in claim 18, wherein an optically inactive peripheral surface of the auxiliary lens extends essentially parallel to the windshield in at least some regions between the entrance surface and the exit surface.

23. The camera system as recited in claim 18, wherein the optical imaging system has (i) a first subsection between an entrance pupil of the objective and the exit surface of the auxiliary lens and (ii) a second subsection which is adjacent to the entrance surface of the auxiliary lens, and wherein at least one of the first and second subsections is angled with respect to the optical axis of the auxiliary lens.

24. The camera system as recited in claim 23, wherein the second subsection is configured to be connected to the inside of the windshield in such a way that the second subsection is not vertically on the inside of the windshield.

25. The camera system as recited in claim 18, wherein the detection region is configured to be at least partially nonplanar.

26. The camera system as recited in claim 18, wherein the optical imaging system is configured to be essentially telecentric at the object side.

27. The camera system as recited in claim 18, wherein the auxiliary lens is one of (i) configured in one piece as a pressed part or (ii) configured as a cast part of at least one transparent material.

28. The camera system as recited in claim 18, wherein the two-dimensional detection area is imaged on the image sensor as a secondary image at a distance from a primary image of the objective corresponding to an outside space which is detected by the detection region.

29. The camera system as recited in claim 28, wherein the image sensor is configured to detect monochromatic radiation for at least the secondary image.

30. The camera system as recited in claim 17, wherein the camera system is mounted in the interior of the vehicle, the detection region of the objective is directed at least partially through the windshield of the vehicle onto the surroundings of the vehicle, and wherein the two-dimensional detection area imaged by the optical imaging system on the image sensor is one of the outside of the windshield or a film present on the outside of the windshield.

31. The camera system as recited in claim 30, wherein an optical auxiliary axis of the imaging system extends downward from the windshield of the vehicle for detecting a lower region of the surroundings of the vehicle for forming a uniform background.

32. The camera system as recited in claim 30, wherein an evaluation device is provided to evaluate a secondary image of the two-dimensional detection area detected from the image signals of the image sensor, and wherein the camera system ascertains whether a film is present on the two-dimensional detection are, a uniform intensity distribution being applied for the background of the secondary image, and structures detected in the secondary image are associated with the film.
